(19) United States
(12) Patent Application Publication
(10) Pub. No.: US 2004/0005536 A1
(43) Pub. Date: Jan. 8, 2004

(54) Universal electronic placement system and method

(76) Inventors: Feng-Qi Lai, Terre Haute, IN (US); Andrew Morrison, Deerfield, IL (US); Joseph J. Bogdan, Chicago, IL (US)

Correspondence Address: GRAY CARY WARE & FREIDENRICH LLP, 2000 UNIVERSITY AVENUE, E. PALO ALTO, CA, 94303-2248, US

(21) Appl. No.: 10/355,729

(22) Filed: Jan. 30, 2003

Related U.S. Application Data
(60) Provisional application No. 60/353,920, filed on Jan. 31, 2002.

(51) Int. Cl. G09B 3/00; G09B 7/00

(52) U.S. Cl. 434/322; 434/362; 434/118

(57) ABSTRACT

A universal electronic placement system and method tests a student's knowledge in a particular subject area, such as phonological awareness, mathematics, natural science, etc. and then generates a recommended placement of the student based on the determined capabilities of the student. The universal electronic placement system and method can be linked to various programs produced by different companies, based on the student's performance results so that the universal electronic placement system and method is universal.

### PRIORITY CLAIM

This application claims priority under 35 U.S.C. §119(e) from U.S. Provisional Application No. 60/353,920 filed on Jan. 31, 2002 and entitled “Universal Electronic Placement Tool System and Method,” which is incorporated herein by reference in its entirety.

### FIELD OF THE INVENTION

This invention relates generally to a computer implemented system and method for automatically placing a user of a system into an appropriate level of training and in particular to a computer implemented system and method for automatically placing a student into an appropriate level of instruction.

### BACKGROUND OF THE INVENTION

Educational software programs are widely used to train a user of the software program in a particular skill or set of skills. Many of the educational software programs have applied adaptive technologies and some of them have hundreds of learning activity levels for each learning task, or game. Electronic assessment tools for testing various subjects, such as phonological awareness for example, are created by various educational software companies. Many of them are sophisticated testing tools that are able to record students' activity patterns and performance results, and generate performance reports for teachers, parents, and students as well.

More and more educational software programs and electronic assessment tools are used at schools. Usually, the teachers use an assessment tool to test a student and, based on the student's performance results, place the student at an appropriate learning level for the particular student. In the alternative, when a teacher is not available to test all her students before using the educational software program, students are simply placed at the lowest learning level of the program when they first start using the software program. These two approaches to placing a student into an appropriate level in the software program present various and different problems. In the case in which an assessment tool is used, the teacher needs to spend a lot of valuable teaching time to test the students and assess their skill levels irregardless of whether paper and pencil assessment or an electronic assessment tool is used, and then must manually place her students one-by-one into the appropriate learning level. This time could be spent on other educational activities for improving teaching strategies. In the case where no placement is performed, students can be placed at inappropriate learning levels. As a result, those students who could start the given program at a higher level would waste their time learning something that was not needed for them and those same students might become bored and lose their motivation.

In the case of using an assessment tool, the tool usually generates recommendations for using a particular software program that is owned by the same company that produced the testing tool. Thus, if a school has several different software programs on the school system and desires to let students use all the programs at appropriate levels, the school has to purchase all of the placement tools from those companies, if they exist, and test their students using different placement tools, which would never be practical. Thus, it is desirable to provide a universal electronic placement system and method that overcomes these problems with typical systems and it is to this end that the present invention is directed.

### SUMMARY OF THE INVENTION

A universal electronic placement system and method are provided (the “universal placement system”). In a preferred embodiment, the universal placement system may be a software program that may be stored on a CD-ROM or other portable storage device, stored and executed on a web site as a Web tool with one or more web pages, or stored on a typical computer and executed by the computer or the like. In general, the universal placement system tests a student's knowledge in a particular subject area, such as phonological awareness, mathematics, natural science, etc. and then generates a placement of the student based on the determined capabilities of the student. The universal placement system can be linked to various programs produced by different companies, based on the student's performance results so that the electronic placement tool is universal. To take advantage of the universal placement system, the only thing a teacher needs to do would be letting a student start the placement test.

In accordance with the invention, a computer implemented apparatus for determining the placement of an individual for training a particular set of skills is provided. The apparatus comprises a processor that executes a placement program wherein the placement program presents a plurality of test items and receives a response for each test item. The placement tool further comprises an error store that stores each incorrect response for each test item and an error measure associated with each incorrect response for each test item. The placement tool further comprises a deficiency module that compares the error measures stored in the error store to a deficiency criteria to identify a particular deficiency and a training recommendation module that recommends a training program and a level for the training program to train the identified deficiency.

In accordance with another aspect of the invention, a computer implemented method for determining the placement of an individual for training a particular set of skills is provided. The method comprises presenting a plurality of test items using a placement tool and receiving a response for each test item. The method further comprises storing, in an error store, each incorrect response for each test item and an error measure associated with each incorrect response for each test item and comparing the error measures stored in the error store to a deficiency criteria to identify a particular deficiency. The method further comprises recommending a training program and a level for the training program to train the identified deficiency.

In accordance with yet another aspect of the invention, a piece of media containing a program for determining the placement of an individual for training a particular set of skills is provided. The piece of media comprises one or more instructions that implement a placement program wherein the placement program presents a plurality of test items and receives a response for each test item. The placement tool further comprises one or more instructions that implement an error store that stores each incorrect response for each test item and an error measure associated with each incorrect response for each test item, one or more instructions of a deficiency module that compares the error measures stored in the error store to a deficiency criteria to identify a particular deficiency and one or more instructions of a training recommendation module that recommends a training program and a level for the training program to train the identified deficiency.

### BRIEF DESCRIPTION OF THE DRAWINGS

FIGS. 1A and 1B illustrate a method for universal, automatic electronic placement in, accordance with the invention;

FIG. 2A illustrates a computer system which may be used to implement the universal placement system in accordance with the invention;

FIG. 2B is a diagram illustrating more details of the computer system shown in FIG. 2A;

FIG. 2C is a diagram illustrating an example of a universal placement system implemented using a personal computer that records a student's performance and capabilities;

FIG. 2D illustrates a piece of media which may be used to implement the universal placement system in accordance with the invention;

FIG. 2E illustrates more details of the universal placement system;

FIG. 3A is a flowchart illustrating an error identification method in accordance with the invention;

FIG. 3B illustrates an example of the error storage database;

FIG. 3C illustrates an example of the rules base that is used to determine the placement of a student;

FIG. 3D illustrates an example of the error measures in accordance with the invention;

FIG. 4 illustrates an example of the form of the performance deficiency summary in accordance with the invention;

FIG. 5 illustrates an example of the prerequisite criteria database in accordance with the invention;

FIG. 6 illustrates an example of the performance learning summary in accordance with the invention;

FIG. 7 illustrates an example of the performance learning summary of FIG. 6 with annotations; and

FIGS. 8A-8C illustrate a method for test item generation in accordance with the invention.

### DETAILED DESCRIPTION OF A PREFERRED EMBODIMENT

The invention is particularly applicable to a phonological awareness educational software electronic placement system and method and it is in this context that the invention will be described. It will be appreciated, however, that the system and method in accordance with the invention has greater utility since it may be used to automatically place a person with respect to a variety of different training including vocational training and other types of educational training such as spelling, mathematics, etc. Now, an embodiment of the universal placement system and method (“universal placement system”) in accordance with the invention which is implemented on a typical personal computer system will be described.

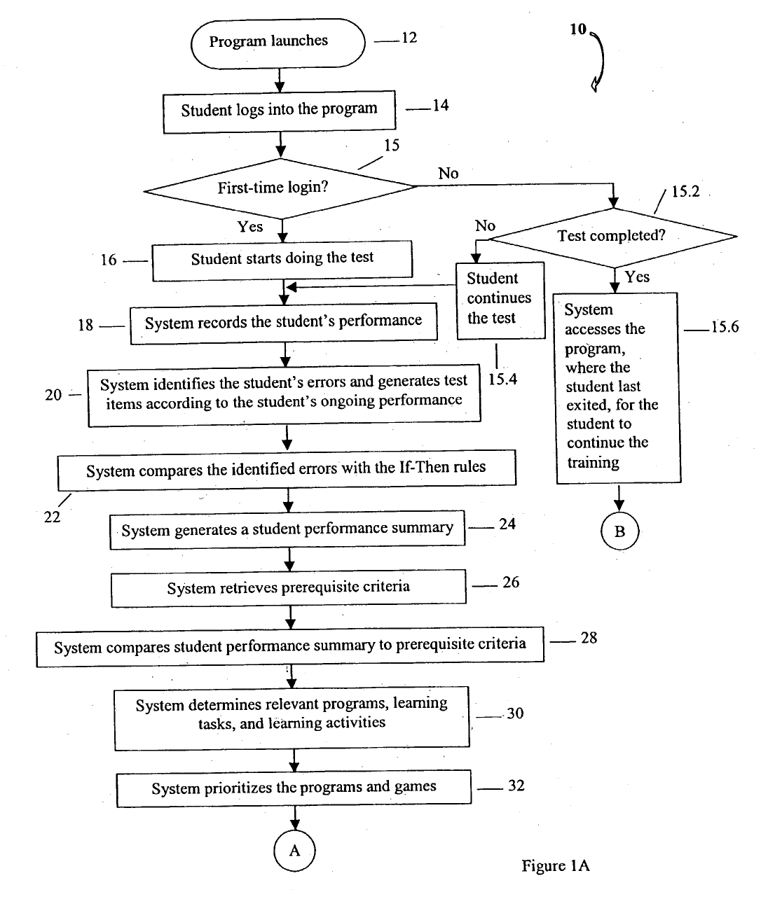

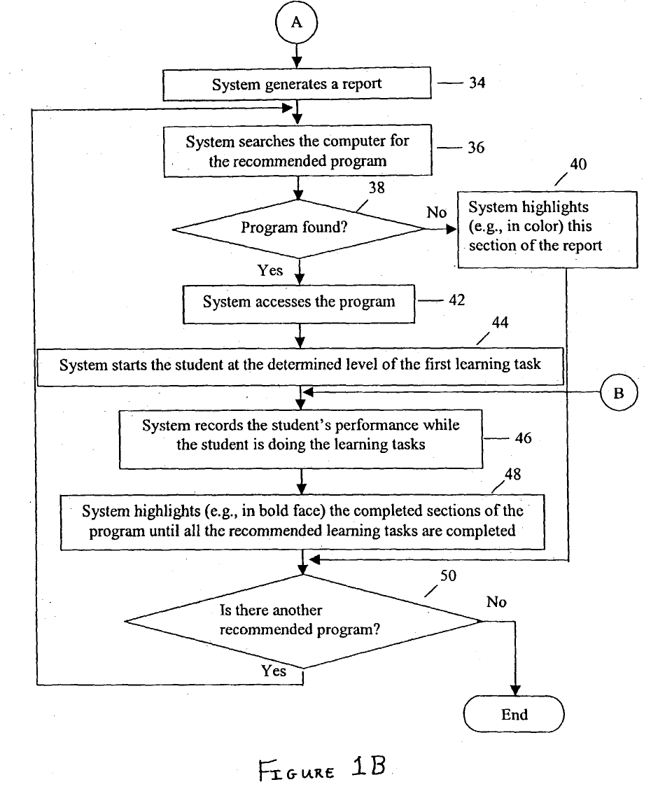

FIGS. 1A and 11B illustrate a method 10 for automatic, universal electronic placement in accordance with the invention. In accordance with the invention, the method described herein may be implemented by a typical computer system. In a preferred embodiment, the universal placement system may be a software program, which may be stored on a piece of media, such as a CD-ROM, which may be inserted into and executed by a typical personal computer, or be a Web-based tool having one or more different web pages, or a streaming software application which is downloaded from the Internet, executed on a local computer system with the results being sent back to a central computer system. Furthermore, the universal placement system in accordance with the invention may be implemented on a variety of different computer systems such as a personal computer (which will be described below), a network of computer systems (such as a peer-to-peer system or other network architecture), a web-based system having a web server and one or more clients with typical browser applications which connect to the web server using a well known protocol, a personal digital assistant (where each student may execute the placement tool on his/her own personal digital assistant), a computer system with a wireless link (such as a personal digital assistant which wirelessly accesses a web server), a cellular phone or the like. Thus, the invention is not limited to any particular computer system implementation.

In general, the universal placement system tests a student's knowledge in a particular subject area, such as Phonological Awareness, Mathematics, Natural Science, Vocational skills, etc. This universal placement system can be linked to various programs produced by different companies, based on the student's performance results, as described below in more detail. The universal placement system permits an individual to be tested to determine the particular individual's skill level in a particular area. The system may generate recommendations for the particular individual which may be used by that individual to properly configure a piece of training software prior to use. The placement system may also permit the automatic configuring of the piece of training software. In the context of a school setting, with the universal placement system, the only thing that a teacher needs to do (in order to assess a student's capabilities in a particular area) would be to permit the student to start the placement test. Now, a preferred method for universal electronic placement using the universal placement system in accordance with the invention will be described in more detail.

Returning to FIG. 1, in step 12, the universal placement system is launched (such as by the user executing the universal placement system software located on a computer system) and the student logs into the universal placement system in step 14. In step 15, using the student's identification and password (which were entered by the user during the log in step above), the universal placement system determines if the student has logged into the universal placement system before. If it is the first time that the student has logged into the universal placement system, the method proceeds to step 16 to start and complete the placement test as described below. If it is not the first time that this student has logged into the universal placement system (e.g., he/she logged: into the universal placement system previously, but did not complete the placement testing), the universal placement system determines if the current placement test is completed in step 15.2. If the current placement test is not completed, the student continues the test from where it was stopped in step 15.4 and then loops to steps 18 and 20 where the student's capabilities and skills are determined. If the current placement test is completed, in step 15.6, the universal placement system accesses where the student last exited (at the next training level/step) so that the student continues training and the method loops to step 46.

When the student has not logged into the system previously, the student starts the placement test in step 16. In step 18, the universal placement system begins recording the student's performance information (all of the user's responses including correct and incorrect responses to test items) as the student is completing the placement testing. In step 20, while recording the performance of the student, the universal placement system 1) identifies the errors that the student made as described below in more detail and 2) generates test items for the student based on the student's ongoing performance. For example, the system may generate a particular test item for a particular student who exhibits a particular skills weakness whereas another student might not complete that test item since the other student does not have the same skills weaknesses as the first student.

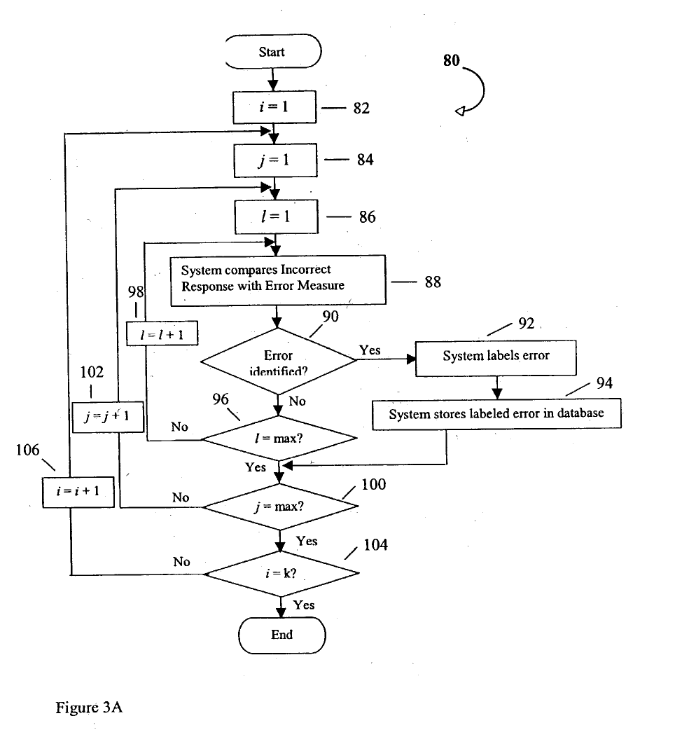

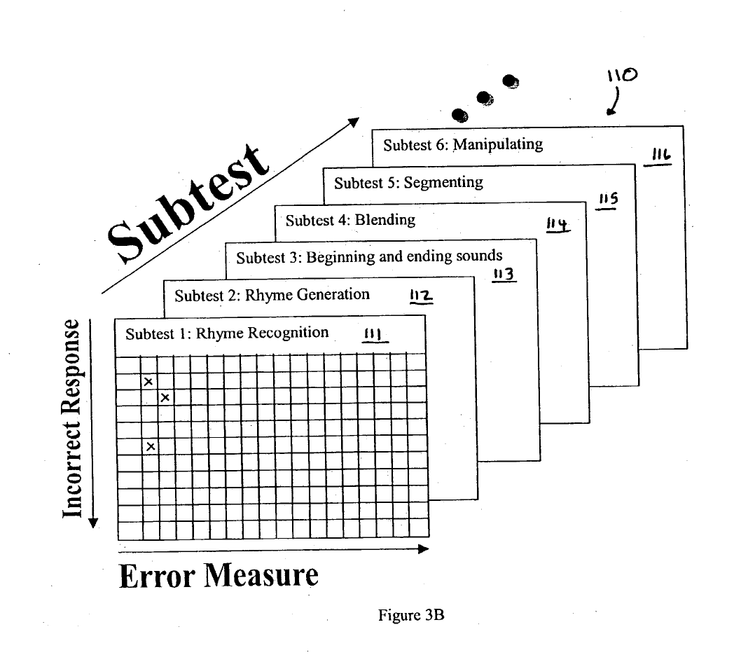

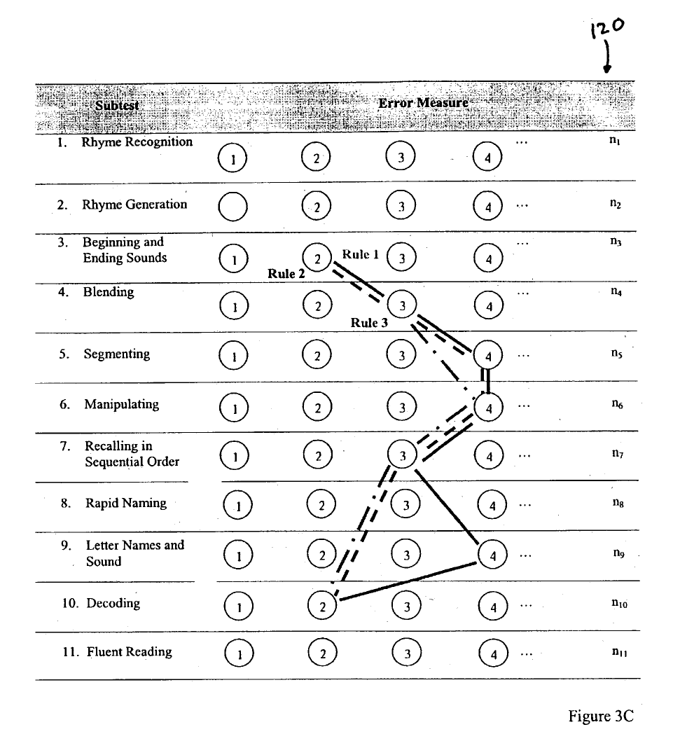

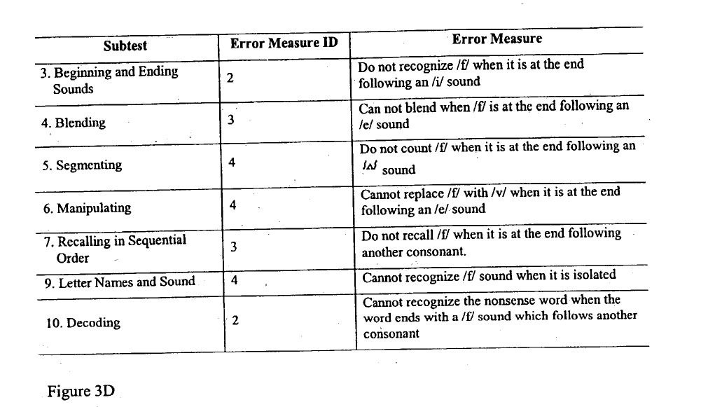

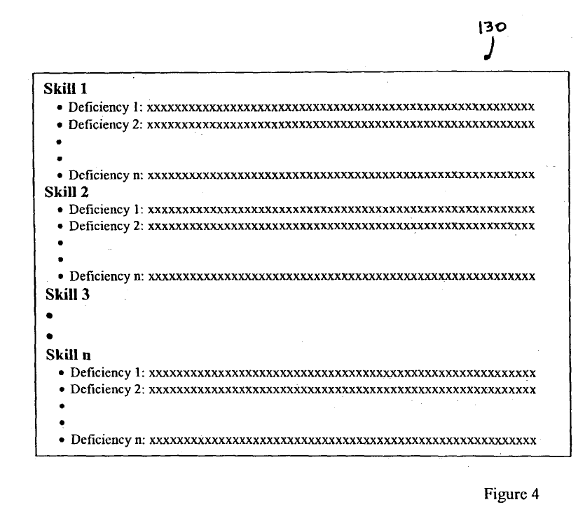

As an example, for a blending sound test with four choices (A, B, C and D), a student might choose answer B (an incorrect answer “house”) while answer A (“horse”) is the correct answer. In step 18, the universal placement system will record the student's incorrect response. Based on that incorrect response, the universal placement system may determine the error (in step 20) made by the student (such as the student is unable to blend a three-sound word.) Then, the identified errors of the student's performance are stored in an error storage database (See FIG. 3B for an example of the error storage database) and compared with the rules from an IF-THEN Rule base to determine which particular skills of the user are identified as being deficient based on the errors made by the user (See FIG. 3C for an example of the preferred IF-THEN Rule base) in step 22. As the result of the comparison, a student performance summary (See FIG. 4 for an example of the summary) is generated upon the completion of the test in step 24.

As is well known, each piece of training software may have one or more prerequisites for each level of the training provided by the training software. For example, it might be necessary to achieve a particular level of proficiency at a particular skill prior to moving to the next level of training. For example, for segmenting learning tasks, segmenting two words in a compound word, for example, “book-case”, is an easier learning task than segmenting two syllables in a word, for example, “ti-ger”, which is an easier learning task than segmenting sounds in a word, for example, “t-i-g-er”. Furthermore, within each learning task, there are different levels. For example, segmenting syllables in a word “ti-ger”, with a 0.25-second time interval between the two syllables “ti” and “ger” is an easier job than with a 0.1-second time interval between the two syllables. Therefore, one could set a learning activity of segmenting a two-syllable word with a 0.25-second time interval as a prerequisite for the activity of segmenting a two-syllable word with a 0.1-second time interval. As another example, for blending learning tasks, the blending of two speech sounds “a-t” into a word “at” is an easier learning task than blending 3 speech sounds “c-a-t” into a word “cat”, which is an easier learning task than blending 4 speech sounds “c-a-t-y” into a word “catty”. Again, there are different levels for each learning task. For example, a 0.25-second time interval between the two sounds “a” and “t” is a more difficult level than with a 0.1 second time interval between the two sounds when a student is blending two sounds into a word. Therefore, one could set a learning activity of blending a two-sound word with a 0.1-second time interval as a prerequisite for the activity of blending a two-sound word with a 0.25-second time interval.

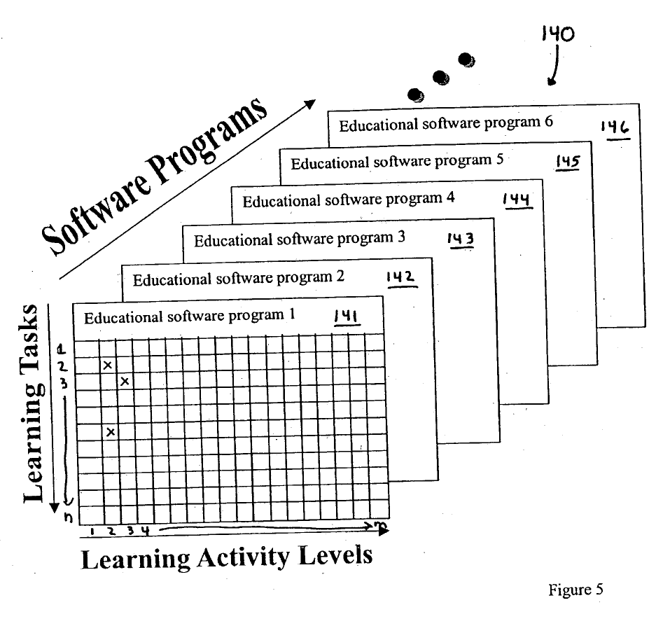

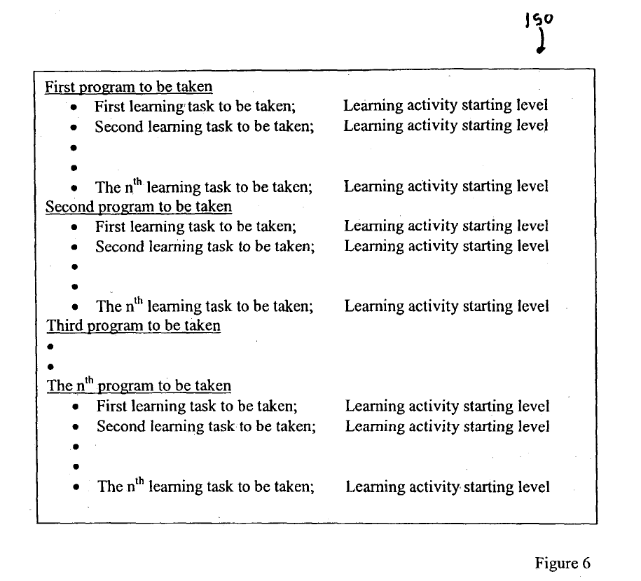

Therefore, in accordance with the invention, the universal placement system may store, for each level of a learning activity of each game of each piece of training software (such as, for example, an educational software program), the prerequisite criteria in a Prerequisite Criteria database (See FIG. 5 for an example of the database). In step 26, the prerequisite criteria are retrieved, one by one. In step 28, each prerequisite criterion is compared to the student's performance summary. In step 30, the universal placement system, based on the comparison results, determines 1) which training program(s) is (are) most relevant for the student to use (for example, Cognitive Concepts Inc.'s Step 1), 2) which learning task(s) is (are) most relevant for the student (for example, blending two-sound words), and 3) at which levels the student should be placed for each learning task (for example, blending two-sound words with a 0.25-second time interval). In step 32, the universal placement system prioritizes the training programs and the games for each program based on the user's individual skill deficiencies. For example, the system may suggest training a first deficient skill of the user which is a prerequisite to the training of another skill. In step 34, the universal placement system generates a report (FIG. 6 illustrates an example of the report generated by the system.) In step 36, the universal placement system searches the computer system where the universal placement system is currently being executed for the educational software program(s) that the student needs to use based on the above analyses in the prioritized order. In step 38, the system determines if the program is found on the computer system. In step 40, if the particular program is not found on the computer system, the universal placement system highlights (for example, in color) those learning tasks of the training program not located on the computer system. In step 42, if the program is found on the computer system, the universal placement system launches the program for the student and directly accesses the determined learning activity level of the first learning task/game that the student needs to take/play in step 44. In step 46, the universal placement system tracks and records the student's performance in completing the learning tasks. In step 48, while tracking and recording the student's performance, the universal placement system highlights, in a different way from highlighting the unfound program (for example, in bold face), those learning tasks that are completed by the student. In step 50, when the educational software program of the first priority is completed, the universal placement system searches for the educational software program of the next priority, if any, and goes through the loop of steps 36-48 until all the recommended learning tasks of each educational software program are completed. Therefore, when the method of the universal placement system in accordance with the invention is completed, the user's proper placement in one or more training programs is determined. Preferably, as long as the training programs are available on the computer system as described above, the universal placement system also trains the user's skills. Thus, the universal placement system may preferably both identify the user's deficient skills and train those deficient skills. Now, the universal placement system will be described in more detail.

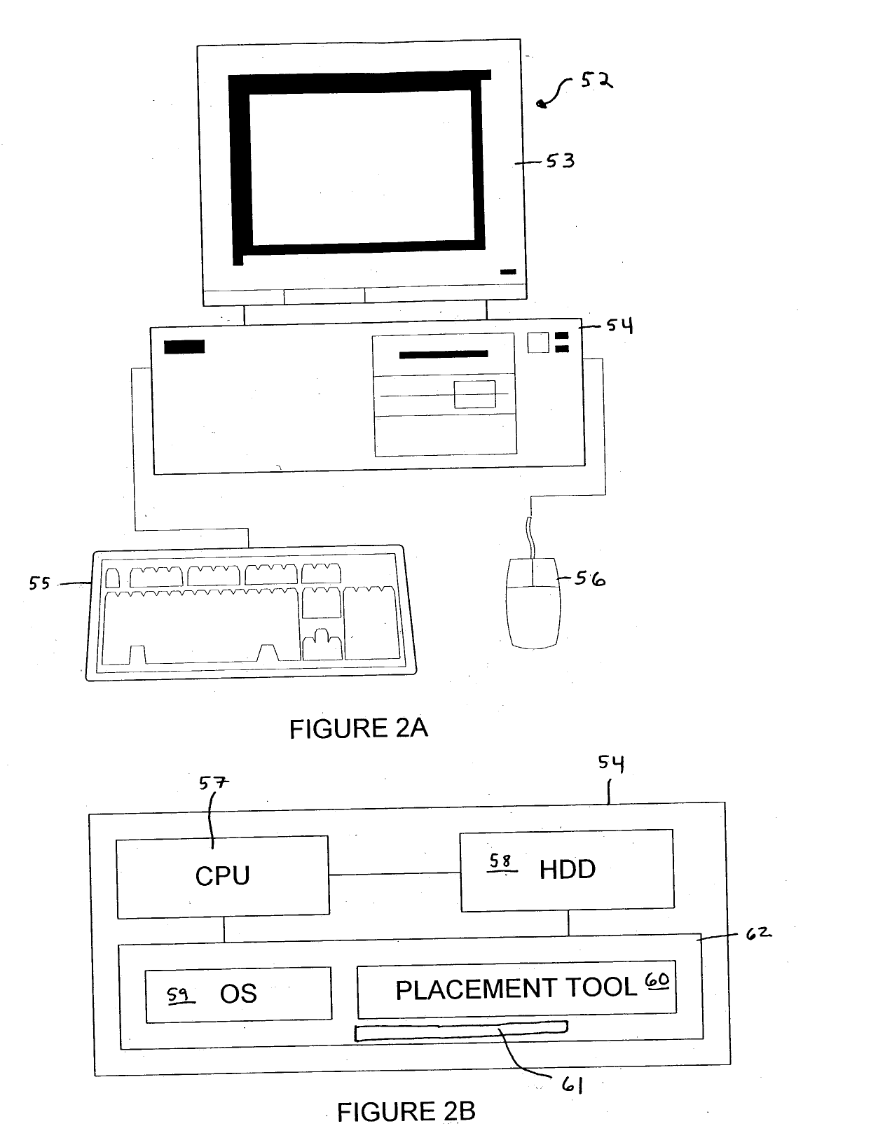

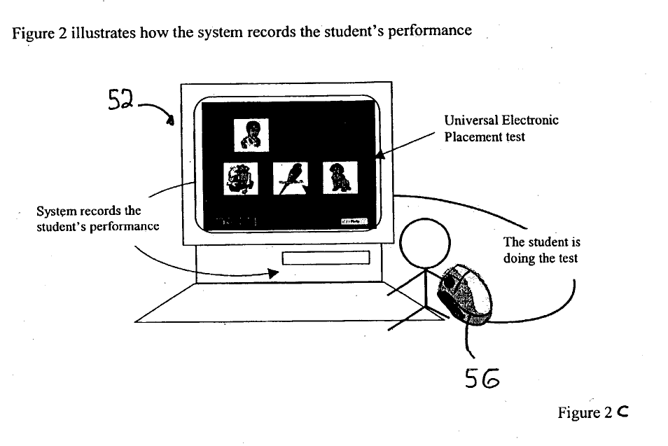

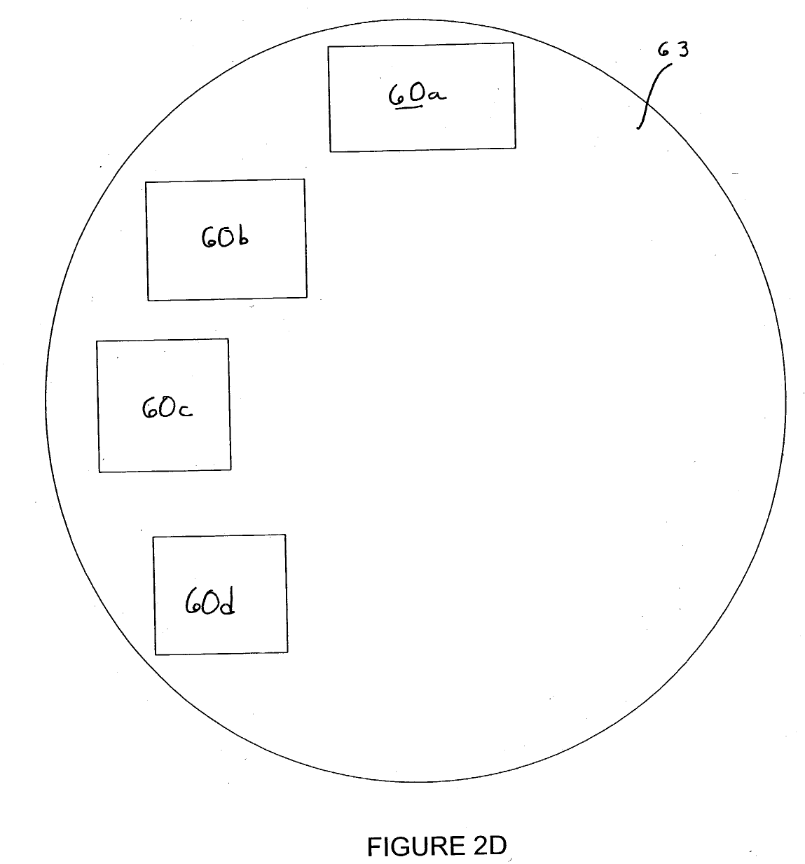

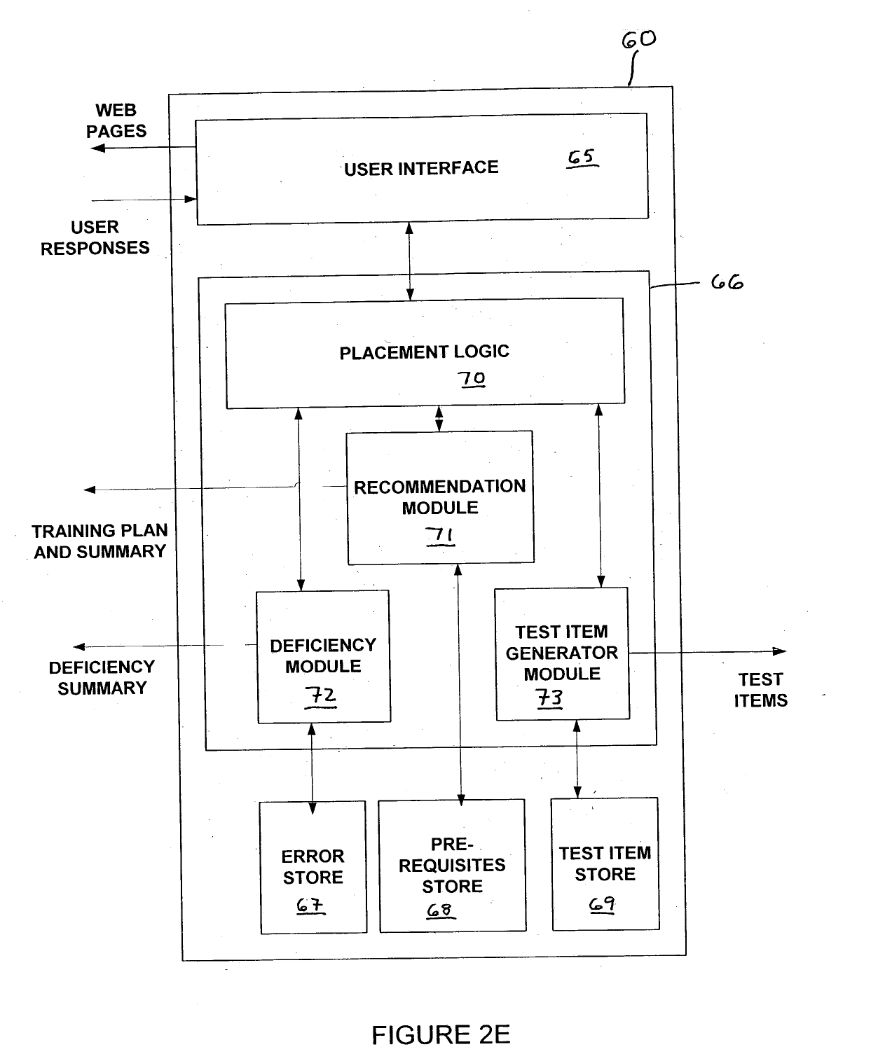

FIG. 2A illustrates an example of a computer system 52 on which the universal placement system may be implemented. The computer system may include a display unit 53, such as a cathode ray tube or LCD, a chassis 54 and one or more input/output devices, such as a keyboard 55 and a mouse 56, which permit the user to interact with the computer system. FIG. 2B illustrates more details of the chassis 54 of the computer system which may include one or more central processing units (CPUs) 57, a persistent storage device 58, such as an tape drive, a hard disk drive, an optical storage drive or the like, and a memory 62, such as DRAM or SRAM. The CPU controls the operation of the computer system and executes instructions to perform operations. The persistent storage device permanently stores data and one or more software programs which are executed by the CPU even when power is removed from the computer system and the memory temporarily stores data and software program(s) currently being executed by the CPU. For example, in FIG. 2B, the memory 62 stores an operating system (OS) 59, a universal placement system program 60 and one or more training programs 61. These programs and data shown stored in the memory may be used in combination to implement the universal placement system in accordance with the invention. In particular, the OS, such as Windows by Microsoft, may control the operation of the computer system, the universal placement system may assess the skills and deficiencies of the user and the one or more training programs may be executed by the universal placement system based on the assessment of the universal placement system program as described above.

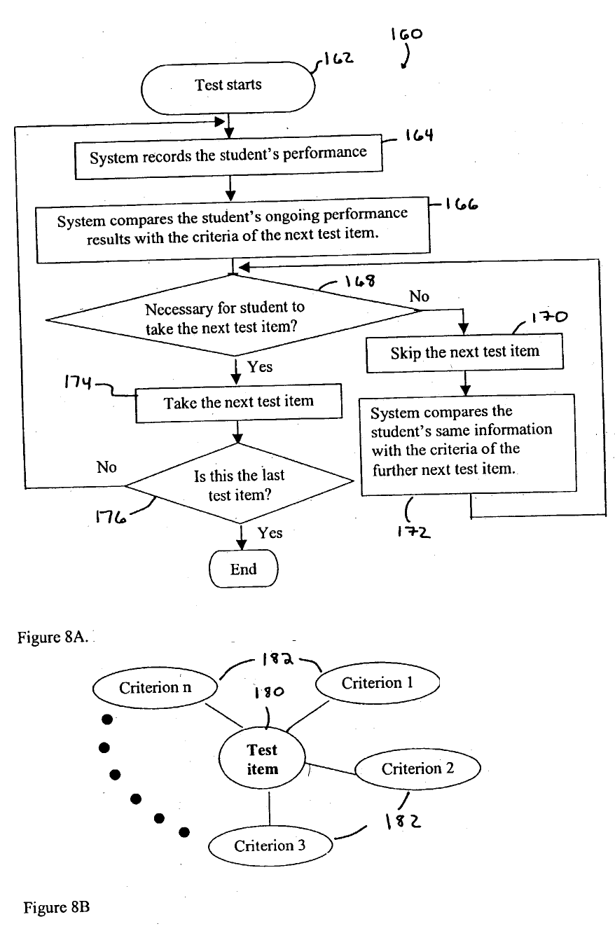

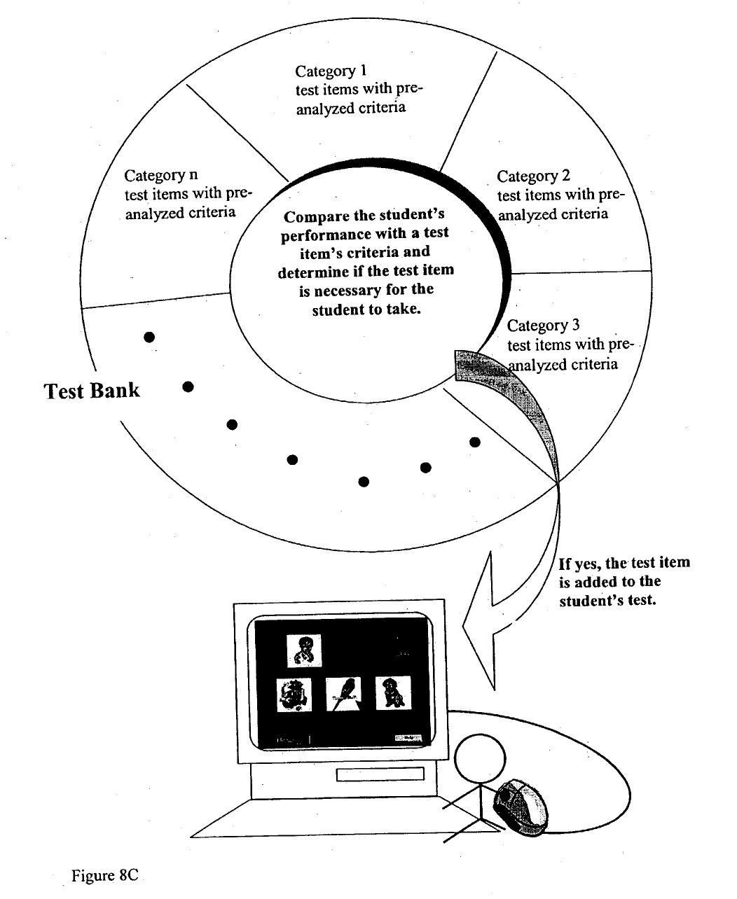

FIG. 2C is a diagram illustrating how the universal placement system on a computer system records a student's performance. In particular, the student may use the computer system 52 to take a placement test. As is well known, the student-may interact with the test using typical input/output devices, such as the mouse 56. The universal placement system may generate its own test items intended to test the student's skills in a particular area as described below with reference to FIGS. 8A-8C. In the example shown, it may be in the phonological awareness area. If the universal placement system is being used for vocational training, then different tests will be used to assess the student's skills for vocational training. As the student takes the test, the universal placement system records the student's performance and preferably trains the user as described in more detail above.

The placement test in the universal placement system may be an achievement test. An example of a placement test item for sound blending will now be described. On the screen, the student may see four pictures: a horse, a dog, a cat, and a house. An animated instructor character says: “This is a horse (the frame of the horse picture is highlighted). This is a dog (the frame of the dog picture is highlighted when the highlight of the frame of the picture horse is turned off). This is a cat (the frame of the cat picture is highlighted when the highlight of the frame of the picture dog is turned off). And this is a house (the frame of the house picture is highlighted when the highlight of the frame of the picture cat is turned off). Click on the word that can be made from these sounds parts: h-or-s (having a 0.25-second time interval between each sounds).” The student has to blend the sounds before he/she is able to click the picture that he/she thinks is the right answer (the “horse” in this example).

FIG. 2D illustrates an example of a piece of media 63 which may be used to implement the universal placement system in accordance with the invention. In particular, the piece of media may store one or more programs and data which are used to implement the universal placement system. As is well known, the piece of media may be inserted into a typical computer system (using, for example, a CD-ROM drive which was not shown in FIG. 2B) so that the computer system executes the programs to implement the placement tool system. In the example shown in FIG. 2D, the piece of media (which may be, for example, a CD-ROM), stores the universal placement system program 60 which may be executed to implement the universal placement system. The universal placement system program 60 may include a plurality of lines of computer code (for example, instructions) as well as the data associated with the universal placement system such as the error storage database, the prerequisite database, the IF-THEN Rule base, the performance summary report generator and the user interface of the universal placement system. In this example, the piece of media may further store one or more modules of the universal placement system, such as a first module 60a, a second module 60b, a third module 60c and a fourth module 60d as shown in FIG. 2D. In a preferred embodiment, the piece of media 63 may store the universal placement system program 60 (and its modules) which will search the computer, into which the piece of media is inserted/installed and executed, for training programs.

FIG. 2E is a diagram illustrating more details of the universal placement system program 60 in accordance with the invention. The program may include a user interface module 65, a universal placement module 66, an error store 67, a pre-requisite store 68 and a test item store 69 as shown. The user interface module, as is well known, generates the user interface which is displayed to the user (including, for example, the login screen, the test items, the deficiency summary and the training summary) and receives the user's responses to the test items and other user information. The universal placement module 66 contains the core logic of the universal placement system. The error store 67 contains the error measures (in a typical database, for example) which is described below in more detail with reference to FIG. 3B, the pre-requisites' store 68 contains the pre-requisite information (in a typical database, for example) which is described below with reference to FIG. 5 and the test item store 69 contains the test items (in a typical database, for example) as described below with reference to FIG. 8C. The user interface module 65 as well as the universal placement module 66 may be implemented, in a preferred embodiment, in software.

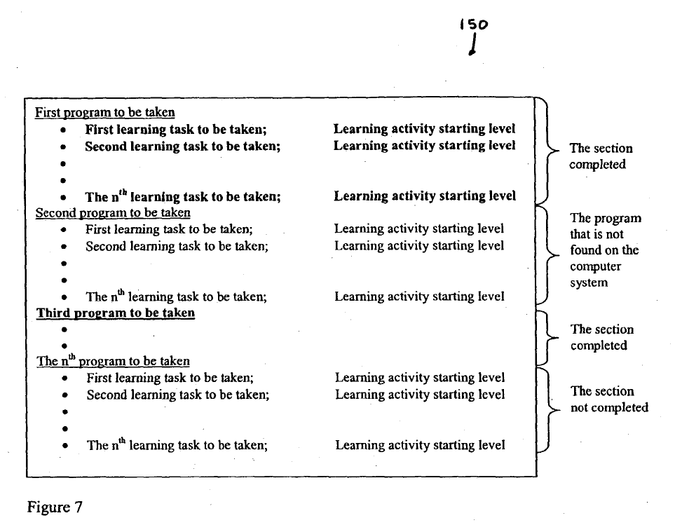

The universal placement module 66 further may comprise placement logic 70, a recommendation module 71, a deficiency module 72 and a test item generator module 73. The placement logic comprises a plurality of lines of software code which, in combination with the recommendation module, the deficiency module and the test item generator module, performs the various operations of the universal placement system. For example, the placement logic 70 may receive each user response and store the error associated with an incorrect answer in the error store 67, it may receive the training plan and training summary report from the recommendation module and forward it to the user, etc. The recommendation module may generate a training plan and summary report (see FIGS. 6 and 7 for an example) based on the information contained in the pre-requisite store 68 as described below in more detail. The deficiency module may generate a deficiency summary (as example of which is shown in FIG. 4) based on the user's responses and the information contained in the error store 67 as described below in more detail. The test item generator module 73 may generate one or more test items which are presented to the user while the user is taking the test as described below with reference to FIGS. 8A-C. In the preferred embodiment of the invention, each of these modules is implemented as a software module which contains a plurality of lines of computer code. Now, a particular preferred software based method for determining the particular type of error based on the answers from a student to all of the subtests in the universal placement system will be described.

FIG. 3A is a flowchart illustrating an example of a preferred error identification method 80 in accordance with the invention. For the examples shown in FIGS. 3A-3D, phonological awareness testing (including student incorrect responses) and errors (identified by the universal placement system in response to the incorrect responses) are being shown and described. However, in accordance with the invention, the error identification method described herein may be used with a variety of different testing subjects and is not limited to any particular testing subject.

The error testing method may include one or more indexes (i, j, l). These indexes are used to indicate various information within the error test method. For example, each subtest (ST)ᵢ, wherein i=1 . . . k and each incorrect responses for each subtest item (IR)ᵢⱼ, wherein i=1.1, 1.2, . . . , 1.max, . . . k.1, k.2, . . . k.max (I=1 . . . max) to track each incorrect response (I=1 . . . max) for each subtest (1 . . . k subtests). Each error measure (EM)ᵢₗ, wherein il=1.1, 1.2, . . . 1.max, . . . k.1, k.2, . . . , k.max (I=1 . . . max) to track each error measure for each subtest. In particular, in steps 82, 84, and 86, the indexes are reset (i.e., set to one) to begin the error testing analysis process. These indexes are then incremented as described below to analyze each incorrect response for each subtest wherein each incorrect response is compared to each error measure to determine the type of error.

In step 88, the first incorrect response, IR₁₁, for the first subtest, ST₁, is compared to the first error measure, EM₁₁, by the system to determine if the first incorrect response is consistent with the first error measure. Each incorrect response used in this error testing method is stored in the error storage database (an example of which is described below with reference to FIG. 3B). In accordance with the invention, each error measure is intended to compare a particular incorrect answer with a particular type of error as described in more detail below with reference to FIG. 3D. In step 90, the method determines if a particular type of error is identified (e.g., ascertains whether the incorrect response indicates that the particular type of problem identified by the particular error measure is present for the particular student). If an error is identified based on the current error measure, the error is labeled by the system in step 92 and then stores the labeled error in the database in step 94 for the particular student.

If an error is not identified based on the current error measure, then the method determines if index l is a maximum (e.g., if all of the error measures have been analyzed) in step 96. If l is not at its maximum value (e.g., there are other error measures that need to be compared to the first incorrect answer for the first subtest), then l is incremented in step 98 (to compare the next error measure to the first incorrect answer to the first subtest) and the method loops back to step 88 to compare the next error measure to the first incorrect answer for the first subtest. Thus, using the loop containing steps 88, 90, 96, and 98, each error measure is compared to the first incorrect answer for the first subtest.

Once each error measure (l=1 to max) is compared to the first incorrect response (j=1) for the first subtest (i=1), the method determines if all of the incorrect responses (j=1 . . . max) have been analyzed in step 100. If all of the incorrect responses have not been analyzed, then the method loops in step 102 to increment (to analyze the next incorrect response) and loops back to step 86 to reset l=1 so that the next incorrect response is compared to all of the error measures. Again, the loop 86, 88, 90, 96, 98, 100, and 102 compares each incorrect response for a particular subtest to each error measure and identifies any matching error measures.

Once all of the incorrect responses (e.g., j=1 . . . max) for a particular subtest (e.g., i=1) have been analyzed, the method proceeds to step 104 in which the method determines if all of the subtests (e.g., i=1 . . . k) have been analyzed. If all of the subtests have not been analyzed, then the index i is incremented in step 106 to analyze the next subtest and the method loops back to step 84 to then analyze each incorrect response for the particular subtest by comparing each incorrect response to each error measure. Again, the loop 84, 86, 88, 90, 96, 98, 100, 102, 104, and 106 compares each incorrect response for each subtest to each error measure.

In summary, the input (IR)₁₁ (incorrect response 1 of subtest 1) is provided and compared to (EM)₁₁ (error measure 1 of subtest 1, for example, open syllable rime). If an error is identified, the error is labeled and stored in the error storage database (an example of which is shown in FIG. 3B.) If the error is not identified, this incorrect response is compared with the remaining error measures until the error is identified. Next, input (IR)₁₂ (incorrect response 2 of subtest 1) is provided and compared to the error measures to identify the error. When all the incorrect responses from subtest 1 are compared and errors are identified, labeled, and stored, the incorrect errors of subtest 2 are input one by one and compared with error measures for subtest 2 as was done for subtest 1. Then, the process is continued for all of the incorrect responses from all of the subtests to identify the errors which are stored in the error storage database. Thus, the method in accordance with the invention compares each incorrect response for each subtest to each error measure to generate a database containing all of the errors that are identified for a particular student. Now, an example of that error storage database will be described.

FIG. 3B illustrates an example of the error storage database 110 for phonological awareness testing. The error storage database would obviously look different for each different type of testing. As shown, for each subtest, such as a Rhyme Recognition subtest 111, a Rhyme Generation subtest 112, a Beginning and Ending Sound subtest 113, a Blending subtest 114, a Segmentation subtest 115, a Manipulating subtest 116, etc, the universal placement system stores the identified errors of the incorrect responses to each question in the subtest. For example, as shown for the Rhyme Recognition subtest 111, in response to the sub-test questions, the user provided incorrect answers to test items 2, 3 and 6 wherein each test item tested a different aspect of the rhyme recognition skills. As shown, the incorrect responses are sorted by the type of error that is likely occurring based on the particular incorrect response wherein those differences are shown graphically in FIG. 3B, but are stored digitally in a database in the preferred embodiment. In this example, two of the incorrect responses indicate the same type of error (for example, an open syllable rime error) and one incorrect response indicates a different type of error (for example, an r-controlled vowel rime). In this manner, the data about the particular incorrect responses by the student stored in the database are mapped into the types of errors that are shown by the particular incorrect answer. Now, more details of the error measure and the comparison of the error measures to the incorrect responses will be described.

FIG. 3C illustrates an example of the IF-THEN Rule base (error measure database) 120 in accordance with the invention. In the example shown in FIG. 3C, a preferred rules base that is used to determine the placement of a student is shown. In this example, the rule base is for phonological awareness testing although a similar rule base (or other error measure database) may be generated for other types of testing. FIG. 3D illustrates an example of one or more subtests of the universal placement system and the error measure associated with each particular subtest for a phonological awareness testing. With reference to FIG. 3C, the circled numbers illustrate the code of an error measure for a particular subtest (shown in more detail in FIG. 3D) and the lines illustrate the connections of all elements for a particular rule that indicates a particular skill deficiency (a deficiency criterion.) The IF-THEN Rule base and the error storage database are known as a deficiency module of the universal placement system program in that a particular deficiency of the user is identified by these elements of the universal placement system. With reference to FIG. 3D, the table illustrates one or more subtests, its associated error measure identification number (ID) and the actual error measure described. Thus, for example, for the Beginning and Ending Sounds subtest, the second error measure identification is “2” and the actual error measure is that the student does not recognize /f/ when it is at the end following an /i/ sound. Other examples of the error measures for different subtests are also shown.

In accordance with the invention, there may be a plurality of error measures that are compared to each incorrect response by the student for each subtest to determine the type of student error that is indicated by the particular incorrect answer; For example, as shown in FIG. 3C, for each subtest, there may be one or more different error measures wherein the error measures are described in more detail in FIG. 3D. Then, once the error measure for each subtest is identified, it is stored in the database. Then, one or more skill deficiencies of the student are determined based on the stored error measures. In particular, the database may include one or more rules that identify different skill deficiencies. Each rule may reach a conclusion about a particular skill deficiency based on one or more error measures. For example, a single error measure (based on a single incorrect answer) may indicate a particular skill deficiency or a combination of error measures (based on more than one incorrect answer) may indicate a skill deficiency. Now, several examples that illustrate the rules set forth in FIGS. 3C (using graphic) and 3D (using text) will be described.

FIG. 3C graphically illustrates three examples of rules in the deficiency module that indicate three different skill deficiencies. FIG. 3C is a simple example of the IF-THEN Rule base for illustration purposes since the IF-THEN Rule base may be three-dimensional with several learning tasks for each subtest and for each learning task there are various activity/difficulty levels. The rules are deficiency measures in that each rule illustrates the error measures which tend to indicate a particular deficiency. These examples, however, are merely illustrative and there may be a very large number of actual skill deficiency rules. FIG. 3D illustrates the error measures that are being used in the rule examples shown in FIG. 3C. In FIG. 3C, the first rule (Rule 1) is indicated by a solid line (----------), the second rule (Rule 2) is indicated by a dashed line (- - - - -), and the third rule (Rule 3) is indicated by a broken dashed line (- . -. - . - . -). Thus, FIG. 3C illustrates the combination of error measures that must be true for a particular student (indicating particular incorrect answers of the student) that in turn indicate a particular skill deficiency. Each example of a rule will now be provided in text below (and shown graphically in FIG. 3C) and then a more in-depth explanation of the first rule only is provided since it is assumed that the second and third rules will be understood once the first rule is explained.

Rule 1: If error measure 3.2 is true (e.g., an incorrect response in the Beginning and Ending Sounds subtest (subtest 3) that matches error measure 2 in FIG. 3D) and error measure 4.3 is true, and error measures 5.4, 6.4, 7.3, 9.4, and 10.2 are true, then the skill deficiency is the /f/ sound.

Rule 2: If error measures 3.2, 4.3, 5.4, 6.4, 7.3, and 10.2 are true, then the skill deficiency is the /f/ sound at the end of a word.

Rule 3: If error measures 4.3, 6.4, 7.3, and 10.2 are true, then the skill deficiency is the /f/ sound at the end of a word following an /e/ sound or another consonant.

In more detail, the first rule generally determines if the student has a deficiency understanding the /f/ sound in a word while the second and third rules determine if the student has a deficiency understanding the /f/ sound in a particular location in a word. To analyze these rules, the database has stored the incorrect answers of the student along with the error measures that correspond to the incorrect responses. Then, each rule is compared to the error measures that are stored in the database which are true (indicating a particular incorrect response to a particular subtest) for the particular student to diagnose any skill deficiency areas. Thus, a deficiency in understanding the /f/ sound is diagnosed if the above identified error measures (indicated in FIG. 3D) are true. Thus, based on a plurality of these rules, a specific deficiency (for example, deficiency of /f/ sound at the end following /e/ sound or another consonant vs. deficiency of /f/ sound) is identified and relevant training modules are chosen.

The universal placement system will ascertain the test items as to which the student provided incorrect responses. If, for example, the two test items as to which the student provided incorrect responses all start with a fricative sound, the system will come to a first conclusion (not the final conclusion) that this student has a skill deficiency with fricative sounds, not other phonemes like stops, nasals, etc. Then the universal placement system ascertains the specific fricative (for example, /f/ not /v/, /s/, /z/, /h/, etc.) with which the student has a skill deficiency. The final conclusion will be made based on the analysis results of one test section combined with the information from other test sections. For example, from another test section, the universal placement system might find that this student has a skill deficiency with this fricative only when it is located at the beginning, not at the end or in the middle of a word; and furthermore, from another test section, the universal placement system might find that this student had problem with this fricative only when it is followed by a specific phoneme (for example, /o/, not /e/, /i/, /ai/, etc.) So, the deficiency of this student is narrowed down. Now, an example of the form of the performance deficiency summary in accordance with the invention will be described.

FIG. 4 illustrates an example of a form 130 of the performance deficiency summary in accordance with the invention. In particular, when all of the deficiencies are located, the universal placement system generates a student performance summary. The summary lists detailed deficiency information about the student's performance (see FIG. 4 for the deficiency information section of the summary). Once this summary is produced, it is necessary to determine which software programs may be used to train the student in the deficient skills which may be done using a prerequisite criteria database as will now be described.

FIG. 5 illustrates an example of the prerequisite criteria database 140 in accordance with the invention. In this example, educational software programs 141-146 will be described but the invention is not limited to any particular type of training. In the universal placement system, there is a prerequisite criteria database 140 that stores prerequisite criteria for different educational software programs 141-146. In particular, for each different software program, there are criteria for each level of each learning activity of each learning task. In FIG. 5, software programs 1, 2, . . . n are different educational software programs, for example, Earobics Step 1, Fast ForWord, etc., in a particular subject area, for example Phonological Awareness. The learning tasks are lessons or games of a program (we can regard a program as a course), for example, blending, segmenting, rhyming, etc. for Earobics Step 1. The learning activity levels are the levels that a lesson or game has, for example, 56 levels for Earobics Step 1 blending game. Thus, for each program, the database stores the prerequisites for a particular learning task (1 to n) and for a particular learning activity level (1 to m) so that the prerequisites for each level of each task is stored in the database. Thus, each cell in FIG. 5 indicates the particular criteria for each learning activity level of each learning task of a program. In accordance with the invention, the database may be generated by the development team of the universal placement system. For example, the criteria may be a two-sound blending with a 0.1 second time interval between the two sounds while another higher level learning activity criteria may be a two-sound blending with a 0.25 second time interval between the two sounds.

Using this database, the universal placement system will retrieve the prerequisite criteria from the database and compare the student's deficiencies with each prerequisite criterion to determine which program(s) and which learning task(s) the student needs to take; and from which learning activity level for each learning task the student should start. The matched level of a task of a program (refer to the “X” sign in FIG. 5 for an example; please note that this mark does not really exist in the database; it is used here for illustration purposes as the data in the database is stored as bits of information) will be recorded. Using the information in the prerequisite database, the universal placement system can generate an optimal plan for the student. For example, if two or more programs have the same learning tasks, for example, both Earobics Step 1 and Step 2 have the blending learning task, the universal placement system will, based on the comparison results, determine which program is more relevant to the student's needs. It is also possible that the student needs to take some learning activities using one program and other activities using the other program, based on the characteristics of the learning task in the different program. The universal placement system in accordance with the invention is therefore able to generate an optimized skill training plan for each particular user to maximize the user's training time and avoid unnecessary training tasks for the user. The prerequisite criteria database and the program to generate the optimized skill training plan is a recommendations module of the placement tool system in that the combination of these elements provides training recommendations to the user. Now, the performance learning summary in accordance with the invention will be described in more detail.

FIG. 6 illustrates an example of the performance learning summary 150 in accordance with the invention. When all programs, learning tasks, and learning activities are determined, the universal placement system will generate a report for the student, prioritizing the programs and learning tasks, and specifying the level for the learning activities. The prioritizing order is determined based on the learning prerequisites of each learning task. In other words, easier learning tasks will be taken before more difficult learning tasks. FIG. 7 illustrates an example of the performance learning summary 150 of FIG. 6 with annotations. The student starts taking the lessons (tasks) accessed automatically by the universal placement system. The tasks that are completed by the student will be highlighted (e.g., in bold face). If the program recommended is not found on the computer system where the universal placement system resides, the relevant section will also be highlighted, but in a different manner (e.g., in color). See FIG. 7 for details. The student can exit the program at any time. When the student next logs in using the universal placement system, he or she will be automatically placed where he or she exited and his or her performance will continue to be recorded. Now, a method for generating placement test items in accordance with the invention will be described in more detail.

FIGS. 8A-8C illustrate an example of a system and method for generating placement test items in accordance with the invention (in a test item generation module of the universal placement system) during the testing of the user so that each test for each user is personalized to the particular user. In particular, the universal placement system may have a test bank as shown in FIG. 8C wherein the test bank stores a plurality of test items. All of the test items for one particular subject, for example, Phonological Awareness, are categorized (for example, blending, rhyming, first sound comparison, etc.) and sorted according to a certain criterion (for example, difficulty levels). Each test item is labeled with criteria that are pre-analyzed. The pre-requisite database for the test items is similar to the pre-requisite database shown in FIG. 5 above. As an example, if a first student provided a correct response to a test item that tests her skill of 3-sound blending with a 0.25 second time interval between the sounds, the next test item to be generated for her may be 4-sound blending with a 0.25 second time interval. If a second student did not provide the correct response to the test item that tests his skill of 3-sound blending with a 0.25 second time interval between the sounds, the system analyzes the possible causes for the second student's incorrect response. In this example, the second student could have one or more deficiencies, including but not limited to 1) an inability to perform 3-sound blending, 2) an inability to complete the task within the 0.25 second time interval, or 3) an inability to identify one sound (for example, “ou”) from another (for example “or”). According to this analysis, the next test item probably is another 3-sound blending test with 0.25 second time interval but without identifying “ou” from “or”. An example of a test item is provided below.

When the student starts doing the test, the universal placement system evaluates the student's performance (compares the student's performance results with the criteria to determine which test items are necessary and which test items are not necessary for the student to take), and generates more test items (retrieves test items from the test item bank accordingly) until the universal placement system has collected enough of that student's performance information sufficient to adequately analyze where to place the student.

As shown in FIG. 8A, a test item generation method 160 begins when the test starts in step 162. In step 164, the universal placement system records the student's performance on the test. In step 166, the universal placement system compares the student's ongoing performance results with the criteria for the next test item. An example of a test item 180 with one or more different criteria 182 is shown in FIG. 8B. For example, the first criterion could be “recognize “or” from “ou”,” a second criterion may be “blending 3 sounds into a word, and a third criterion may be “at a difficulty level of a 0.25-second time interval,” and so on, and so forth. So, if a student chooses “house” (incorrect) instead of “horse” (correct), the student most likely does not meet the first criterion. However, we do not know if the student meets the other criteria. So, the next test item would be a blending test item at the same level but does not include the foil “house.” For example, the four choices would be: “cat,” “dog,” “bird,” and “horse.” If, with this new test item, the student is still unable to choose the correct answer (e.g., the student chooses “dog” for “horse,”), the student also does not meet the second criterion and/or the third criterion. So, according to this result, the next test item would be either a 2-sound blending with a 0.25-second time interval, or a 3-sound blending with a 0.1-second time interval to determine if the student does not meet the second criterion or third criterion.

In step 168, the universal placement system determines if it is necessary for the student to take the next test item based on the above comparison. If the student does not need to take the next test item, the next test item is skipped in step 170 and the universal placement system then compares the student's performance results with the criteria for the further next test item in step 172 and the method loops back to step 168. If the student does need to take the next test item, the next test item is presented to the student in step 174. In step 176, the universal placement system determines if the previous test item is the last test item and the method, loops back to step 164 if there are further test items. If there are no more test items, the method is completed. In this manner, the placement testing provided to each user is unique in that the universal placement system presents only the relevant test items to each user. Thus, the universal placement system reduces the irrelevant test items and therefore increases the efficacy of the placement testing and the validity of the test results (because when too many irrelevant test items are provided, a student may feel tired and lose interest and not pay attention to the test so that the test results may not be valid.)

While the foregoing has been with reference to a particular embodiment of the invention, it will be appreciated by those skilled in the art that changes in this embodiment may be made without departing from the principles and spirit of the invention as set forth in the claims set forth below.

1. A computer implemented apparatus for determining the placement of an individual for training a particular set of skills, the apparatus comprising:
a processor that executes a placement program wherein the placement program presents a plurality of test items and receives a response for each test item; and the placement program further comprising an error store that stores each incorrect response for each test item and an error measure associated with each incorrect response for each test item, a deficiency module that compares the error measures stored in the error store to a deficiency criteria to identify a particular deficiency and a training recommendation module that recommends a training program and a level of a learning task for the training program to train the identified deficiency.

2. The apparatus of claim 1, wherein the placement program further comprises a plurality of subtests that each test a different skill and wherein each subtest has one or more test items associated with the subtest.

3. The apparatus of claim 1, wherein the placement program further comprises a test item generation module that selects particular test items for a particular user based on the prior responses from the user to one or more test items.

4. The apparatus of claim 3, wherein the test item generation module further comprises a test item database that stores a plurality of test items and an associated criteria for each test item wherein the criteria determines if a particular test item is presented to a particular user.

5. The apparatus of claim 1, wherein the error store further comprises an error storage database that contains one or more error measures associated with each test item wherein each error measure indicates an identified skill deficiency associated with an incorrect answer to a particular test item.

6. The apparatus of claim 1, wherein the deficiency module further comprises a deficiency database that contains, one or more deficiency measures wherein each deficiency measure indicates one or more error measures from the subtests that identify a particular deficiency.

7. The apparatus of claim 6, wherein the deficiency database further comprise an IF-THEN rule base having a plurality of rules wherein each rule specifies that if one or more error measures are present, then a particular deficiency is identified.

8. The apparatus of claim 1, wherein the placement program further comprises a deficiency summary reporting module that generates a deficiency summary report indicating one or more deficiencies of a particular user based on the error analysis of the incorrect responses to the test items.

9. The apparatus of claim 1, wherein the training recommendation module further comprises a prerequisites criteria database that associates a particular skill criteria for each training program.

10. The apparatus of claim 9, wherein the prerequisite criteria database further comprises, for each training program, a skill criteria for each learning task of each training program so that the apparatus recommends a training program and a learning task of the training program appropriate for a particular user.

11. The apparatus of claim 10, wherein the prerequisite criteria database further comprises, for each learning task, a skill criteria for each level of each learning task so that the apparatus recommends a learning task and a level of the learning task of the training program appropriate for a particular user.

12. The apparatus of claim 1, wherein the training recommendation module generates a training program summary that indicates the training programs, the learning tasks of the training programs and the levels for each learning task for the particular user.

13. The apparatus of claim 12, wherein the training program summary indicates training programs that are accessible by the placement program, training programs which are not accessible by the placement program and training programs completed by the user.

14. A computer implemented method for determining the placement of an individual for training a particular set of skills, the method comprising:
presenting a plurality of test items using a placement program;
receiving a response for each test item;
storing, in an error store, each incorrect response for each test item and an error measure associated with each incorrect response for each test item;
comparing the error measures stored in the error store to a deficiency criteria to identify a particular deficiency; and
recommending a training program and a level of a learning task for the training program to train the identified deficiency.

15. The method of claim 14, wherein the placement program further comprises a plurality of subtests that each test a different skill and wherein each subtest has one or more test items associated with the subtest.

16. The method of claim 14, wherein the test item generation further comprises selecting particular test items for a particular user based on the prior responses from the user to one or more test items.

17. The method of claim 16, wherein the test item generation further comprises storing a plurality of test items and an associated criteria for each test item wherein the criteria determines if a particular test item is presented to a particular user.

18. The method of claim 14, wherein the storing further comprises storing one or more error measures associated with each test item wherein each error measure indicates an identified skill deficiency associated with an incorrect answer to a particular test item.

19. The method of claim 14, wherein the comparing further comprises storing one or more deficiency measures wherein each deficiency measure indicates one or more error measures from the subtests that identify a particular deficiency.

20. The method of claim 19, wherein the storing of the deficiency measures further comprise storing the deficiency measures in an IF-THEN rule base having a plurality of rules wherein each rule specifies that if one or more error measures are present, then a particular deficiency is identified.

21. The method of claim 14, further comprising generating a deficiency summary reporting module that generates a deficiency summary report indicating one or more deficiencies of a particular user based on the error analysis of the incorrect responses to the test items.

22. The method of claim 14, wherein the recommendation further comprises comparing a particular skill criteria for each training program stored in a prerequisite criteria database in order to recommend the training program.

23. The method of claim 22, wherein the prerequisite criteria database further comprises, for each training program, a skill criteria for each learning task of each training program so that the method recommends a training program and a learning task of the training program appropriate for a particular user.

24. The method of claim 23, wherein the prerequisite criteria database further comprises, for each learning task, a skill criteria for each level of each learning task so that the method recommends a learning task and a level of the learning task of the training program appropriate for a particular user.

25. The method of claim 14, wherein the training recommendation further comprises generating a training program summary that indicates the training programs, the learning tasks of the training programs and the levels for each learning task for the particular user.

26. The method of claim 25, wherein the training program summary indicates training programs that are accessible by the placement program, training programs which are not accessible by the placement program-and training programs completed by the user.

27. A piece of media containing a program for determining the placement of an individual for training a particular set of skills, the piece of media comprising:
one or more instructions that implement a placement program wherein the placement program presents a plurality of test items and receives a response for each test item;
the placement program further comprising one or more instructions that implement an error store that stores each incorrect response for each test item and an error measure associated with each incorrect response for each test item; one or more instructions of a deficiency module that compares the error measures stored in the error store to a deficiency criteria to identify a particular deficiency and one or more instructions of a training recommendation module that recommends a training program and a level for the training program to train the identified deficiency.

28. The piece of media of claim 27, wherein the placement program further comprises a plurality of subtests that each test a different skill and wherein each subtest has one or more test items associated with the subtest.

29. The piece of media of claim 27, wherein the placement program further comprises a test item generation module that selects particular test items for a particular user based on the prior responses from the user to one or more test items.

30. The piece of media of claim 29, wherein the test item generation module further comprises a test item database that stores a plurality of test items and an associated criteria for each test item wherein the criteria determines if a particular test item is presented to a particular user.

31. The piece of media of claim 27, wherein the error store further comprises an error storage database that contains one or more error measures associated with each test item wherein each error measure indicates an identified skill deficiency associated with an incorrect answer to a particular test item.

32. The piece of media of claim 27, wherein the deficiency module further comprises a deficiency database that contains, one or more deficiency measures wherein each deficiency measure indicates one or more error measures from the subtests that identify a particular deficiency.

33. The piece of media of claim 32, wherein the deficiency database further comprise an IF-THEN rule base having a plurality of rules wherein each rule specifies that if one or more error measures are present, then a particular deficiency is identified.

34. The piece of media of claim 27, wherein the placement program further comprises a deficiency summary reporting module that generates a deficiency summary report indicating one or more deficiencies of a particular user based on the error analysis of the incorrect responses to the test items.

35. The piece of media of claim 27, wherein the training recommendation module further comprises a prerequisite criteria database that associates a particular skill criteria for each training program.

36. The piece of media of claim 35, wherein the prerequisite criteria database further comprises, for each training program, a skill criteria for each learning task of each training program so that the piece of media recommends a training program and a learning task of the training program appropriate for a particular user.

37. The piece of media of claim 36, wherein the prerequisite criteria database further comprises, for each learning task, a skill criteria for each level of each learning task so that the piece of media recommends a learning task and a level of the learning task of the training program appropriate for a particular user.

38. The piece of media of claim 27, wherein the training recommendation module generates a training program summary that indicates the training programs, the learning tasks of the training programs and the levels for each learning task for the particular user.

39. The piece of media of claim 38, wherein the training program summary indicates training programs that are accessible by the placement program, training programs which are not accessible by the placement program and training programs completed by the user.

40. A method for generating a test item for a placement test, the method comprising:
recording the current test item, response of the user to a current test item presented to the user;
comparing the current test item response to a criteria associated with the next test item; and
skipping the next test item when the criteria for the next test item is satisfied by the user based on the current test item response so that only the test items which are relevant to the user are presented to the user.

41. The method of claim 40 further comprising presenting the next test item to the user when the criterion for the next test item is not satisfied by the user based on the current test item response.

42. A method for determining the skill deficiency of a user based on a placement test, the method comprising:
recording the incorrect responses of a user to a plurality of test items in a placement test;
comparing each incorrect response to each one of a plurality of error measures to identify the errors of the user based on the placement test; and
generating a deficiency measure indicating a deficient skill of the user based on the identified errors of the user.

43. The method of claim 42, wherein generating the deficiency measure further comprises comparing the identified errors of the user to a rule having one or more pre-requisite errors wherein the deficiency measure is generated when the pre-requisite errors are identified for the particular user.
